(19) United States
(12) Patent Application Publication
(10) Pub. No.: US 2015/0125246 A1
(43) Pub. Date: May 7, 2015

(54) OVEN TRANSFER APPARATUS HAVING A DISCONTINUOUS CONVEYOR BELT

(71) Applicant: HAAS FOOD EQUIPMENT GMBH, WIEN (AT)

(72) Inventors: Johannes Haas, Wien (AT); Josef Haas, Leobendorf (AT); Stefan Jiraschek, Koenigsbrunn (AT); Peter Lambauer, Hitzendorf (AT)

(21) Appl. No.: 14/406,281

(22) PCT Filed: May 16, 2013
(86) PCT No.: PCT/EP2013/060163

§ 371 Date: Dec. 8, 2014

(30) Foreign Application Priority Data
Jun. 8, 2012 (AT) A656/2012

(51) Int. Cl. A21B 3/07; B65G 15/48; B65G 47/52; A21C 9/08; B65G 15/60

(52) U.S. Cl. CPC A21B 3/07; A21C 9/08; B65G 15/60; B65G 47/52; B65G 15/48
USPC 414/586

(57) ABSTRACT

An apparatus for transporting and for transferring substantially non-rigid cookie shaped bodies onto a heated surface such as, for example, a baking belt of a cookie (biscuit) baking machine. The apparatus has a circulating, driven belt-shaped conveyor belt, which is guided around at least one deflecting roller, around a drive roller and, in the vicinity of the heated surface, around a transfer edge. The conveyor belt is a discontinuous belt, in particular a discontinuous metal belt, and the conveyor belt is substantially resistance-strain relieved at the starting region of the transfer edge when the conveyor belt is moving.

The invention relates to an apparatus for transporting and for transferring substantially non-rigid shaped bodies onto a heated surface such as, for example, a baking belt of a baking machine, where the apparatus comprises a circulating, driven belt-shaped conveyor belt, which is guided around at least one deflecting roller, around a drive roller and in the region of the surface around a transfer edge. The invention further relates to a cookie (biscuit) baking oven on which the apparatus for transporting and for transferring substantially non-rigid shaped bodies is provided.

The field of the invention relates to apparatus for transferring shaped bodies such as, for example, unbaked flat round dough cakes, unbaked cookie shaped bodies, unbaked dough pieces etc. and in particular over transfer belts for transferring flat, unbaked cookie dough shaped bodies onto the hot baking belt of a baking machine.

In order not to damage the shaped bodies during transfer, the shaped bodies must be transferred as gently as possible from the transfer belt onto the baking belt. To this end, the transfer belt is guided as close as possible to the baking belt. Furthermore, the transfer angle, i.e. the angle between the transfer belt and the baking belt, should preferably be designed to be as obtuse as possible.

Apparatus corresponding to the prior art have a plastic belt guided over a plurality of rollers which is driven in a circulating manner by a drive. In the area of the baking belt of the baking machine, the plastic belt is guided around a transfer edge. This transfer belt is preferably designed according to the prior art to be as sharp as possible. Furthermore, the transfer belt and the transfer edge are guided as close as possible to the baking belt of the baking machine.

A disadvantage with this apparatus is that the plastic belts have a too-low temperature resistance. Damage to the plastic occurs as a result of bringing the plastic belt close to the hot baking belt. In order to counteract this effect, the distance between the plastic belt and the baking belt must be increased which in turn has a detrimental influence on the quality of the transfer.

Furthermore, belt conveyors are known in the prior art which have a discontinuous metal strip as a circulating belt. Belt-shaped bodies which are composed of a plurality of bodies or which have a discontinuous structure or surface are designated as discontinuous belts. Examples of discontinuous belts are chain belts, link belts or spiral link belts etc. Discontinuous metal belts are certainly temperature-resistant but according to the prior art, it is not possible to guide these belts around a sharp transfer edge. As a result of the rigid subsections of the discontinuous metal belt arranged in a chain shape, severe wear occurs at the transfer edge. Furthermore, irregularities occur in the advancement of the belt. This in turn has a negative influence on the quality of the transfer.

The basic configuration of belt conveyors according to the prior art provides that the conveyor belts are pulled around or over the transfer edge. In the case of circulating conveyor belts the tensile stress in the region directly after the drive is the lowest. In the course of the belt a plurality of deflecting rollers, optional tensioning rollers and deflecting edges are provided. All these elements are liable to friction and exert a resistance on the movement of the conveyor belt. Consequently, the stress increases further in the circumferential direction at each of these elements contacting the conveyor belt. The conveyor belt therefore exhibits the maximum stress in the region ahead of the drive roller.

According to the prior art, in belt conveyors it should be avoided that the conveyor belt has regions in which no pull acts on the conveyor belt. In particular, in the case of chain belts, link belts or spiral link belts, a compression or arching of the belt occurs in the case of complete strain relief or compressive load. In order to avoid this, tensioning rollers are usually disposed in the course of the conveyor belt. Additionally to this, the drive roller is disposed downstream of the region having the highest resistance.

According to their manufacturer's details, known spiral link belts, link belts and chain belts have a minimum deflection radius of several centimetres. However, this deflection radius is too large to thus achieve a high-quality and gentle transfer of the shaped bodies.

It is now the object of the invention to provide an apparatus for transporting and transferring substantially non-rigid shaped bodies onto a heated surface such as, for example, a baking belt, the conveyor belt whereof is temperature-resistant, in particular temperature-resistant to the temperature of the baking belt, which can be deflected around a sharp transfer edge and which is favourable to manufacture and uncomplicated to maintain. The superordinate object is to provide an apparatus which allows a high-quality transfer and which furthermore has a long lifetime and thus can be operated with low maintenance costs.

The objects according to the invention are solved whereby the conveyor belt is designed as a discontinuous belt and that the conveyor belt is substantially strain-relieved and/or resistance-strain relieved in the starting region of the transfer edge. A state of the conveyor belt in which the lowest tensile forces occur along the course of the conveyor belt is defined as substantially strain-relieved. Preferably the tensile forces are approximately zero. However, it is also consistent with the inventive idea that in the starting region of the transfer edge, the conveyor belt is held under tension to a small extent. A local tension state of the conveyor belt in which the tension of the conveyor belt substantially corresponds to the basic tension of the belt and/or in which the conveyor belt is substantially free from resistance tension is defined as resistance-strain-relieved. In the case of endless conveyor belts, the conveyor belt preferably has a basic tension which is substantially constant along the entire conveyor belt. When the conveyor belt is moving, starting from the drive, the tension of the conveyor belt increases further at each element liable to friction, which contacts the conveyor belt. This tension is designated as resistance tension. The basic tension is produced, for example, by tensioning rollers and/or by the mass of the conveyor belt and gravity. The basic tension can however optionally also be zero or have negative values. In resistance-strain-relieved regions the lowest tensile force occurs along the course of the conveyor belt if no further elements which reduce the tension of the belt are provided.

Further advantageous features of the invention are that the transfer edge and/or the transfer blade has a maximum deflection radius of 5 mm, preferably a maximum of 3 mm and/or that the transfer edge has a maximum deflection angle of the conveyor belt of 45°, preferably a maximum of 20°.

The invention is further characterized in that the conveyor belt has the lowest tensile stress in the starting region of the transfer edge or in the region between the drive roller and the transfer edge and/or that the conveyor belt has a substantially constant basic tension and a resistance tension produced by friction and that in the starting region of the transfer edge or in the region between the drive roller and the transfer edge, the conveyor belt is substantially free from resistance tension or that only the basic tension acts in this region.

According to the invention, it can be provided that the region between the drive roller and the transfer edge is free from deflection rollers contacting the conveyor belt, free from deflection rollers liable to friction and contacting the conveyor belt and/or free from elements which increase the tensile force of the conveyor belt and which contact the conveyor belt, that at least one deflection roller is designed as a tensioning roller, that the conveyor belt is designed as a discontinuous metal belt, as a chain belt, as a link belt, as a spiral link belt or as a compressible spiral link belt, that the deflection edge is provided at a deflection blade and/or that the deflection blade is designed to be movable for positioning with respect to the surface.

The invention is further characterized in that the conveyor belt has openings for passage of contaminants, liquids or scattered bodies, that a collector is provided for collecting contaminants, liquids or scattered bodies passing through the conveyor belt, that guide means are provided for guidance and/or for support of the conveyor belt against gravity, that the guide means are disposed following the desired profile of the conveyor belt and/or that the apparatus is adapted for transferring substantially non-rigid shaped bodies from a cutting-out system to an industrial cookie baking oven.

The invention further relates to a cookie baking oven, on which an apparatus according to the invention is provided and/or which comprises an apparatus according to the invention.

According to the present invention, the drive roller is disposed along the conveyor belt in the region directly upstream of the transfer edge. A prejudice of the technical world whereby the drive roller must be disposed downstream of the region having the highest resistance is thereby overcome.

In the apparatus according to the invention, contrary to the view of the technical world, the drive belt is disposed in a region in the transport direction upstream of the transfer edge. The conveyor belt is preferably disposed in the region between the transfer edge and the drive roller free from further elements liable to friction such as deflecting rollers, transfer edges etc. Consequently the conveyor belt is pushed in the transport direction substantially in the direction of the transfer edge or conveyed at least in a substantially strain-relieved or resistance-strain-relieved manner. In this region between the transfer edge and the drive roller, the conveyor belt has the lowest tension.

This arrangement according to the invention allows a deflection radius of less than 5 mm to be achieved for the first time. Furthermore, due to the strain relief and/or the low tension in the region of the transfer edge, the wear at the transfer edge is advantageously minimised, the running of the belt is quiet and uniform and a sharp deflection is made possible.

As a result of the arrangement of a discontinuous belt as a conveyor belt and a sharp transfer edge, it is possible to achieve a high-quality and gentle transfer of the shaped bodies from the conveyor belt onto the baking belt. As a result of the high temperature resistance of the belt, which is preferably designed as a discontinuous metal belt, this can be guided close to the baking belt without being damaged by the heat.

A further advantage obtained by using, for example, a spiral link belt is that loose parts such as for example parts of the shaped bodies, scattered material for application to the shaped bodies etc. can drop through openings of the discontinuous metal belt. As a result, these contaminants are not conveyed onto the baking belt of the oven and into the oven.

The apparatus according to the invention is preferably used “inline” in a line for the industrial production of baked goods. In particular the apparatus is adapted to convey substantially non-rigid shaped bodies such as, for example, unbaked cookie shaped bodies from, for example, a cutting apparatus for forming, for example, round cookies to a surface, for example, the oven belt of a cookie baking oven.

The present apparatus preferably comprises a control unit. This control unit is suitable and/or adapted to control and/or regulate parameters such as the rotational speed of the drive roller and the transport speed along the transport surfaces. To this end, its own control unit can be provided per apparatus. Preferably however a control unit is provided which is adapted to control the baking machine or the cookie baking oven. Alternatively to this the apparatus according to the invention can comprise a control unit which is connected to the control unit of a baking machine.

The invention is explained further hereinafter with reference to specific exemplary embodiments.

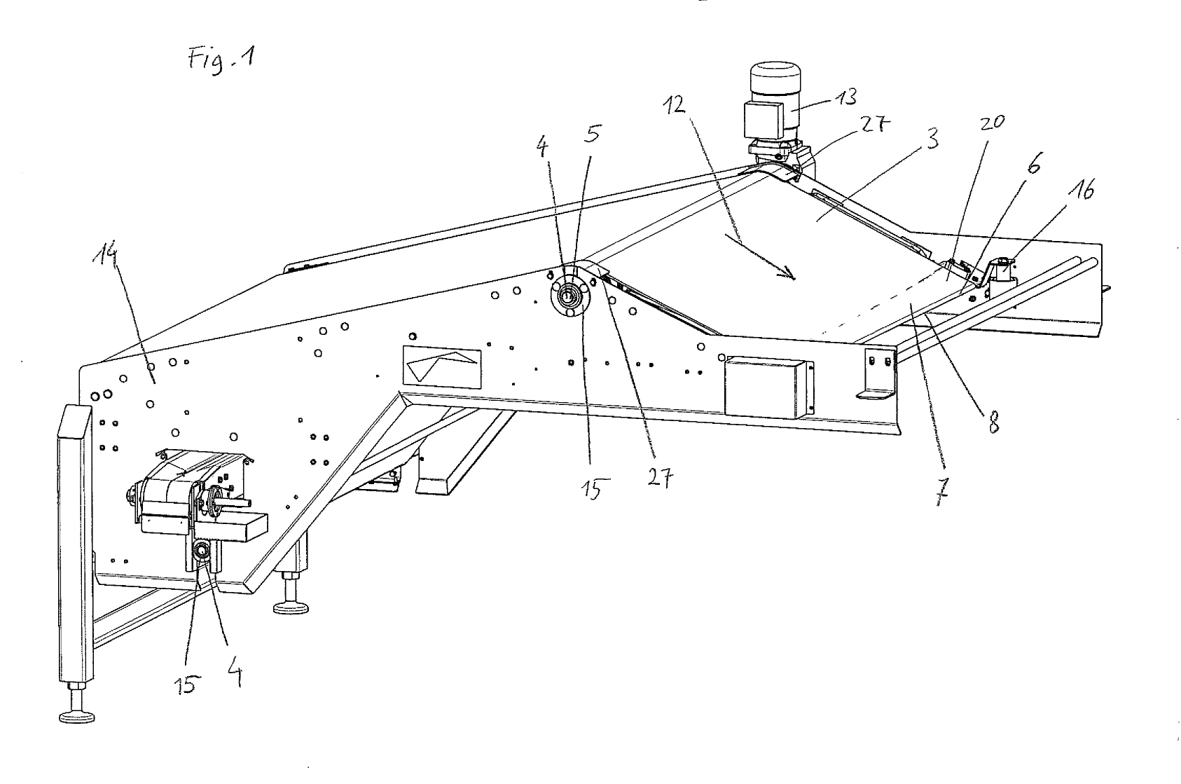

FIG. 1 shows a schematic oblique view of the apparatus according to the invention.

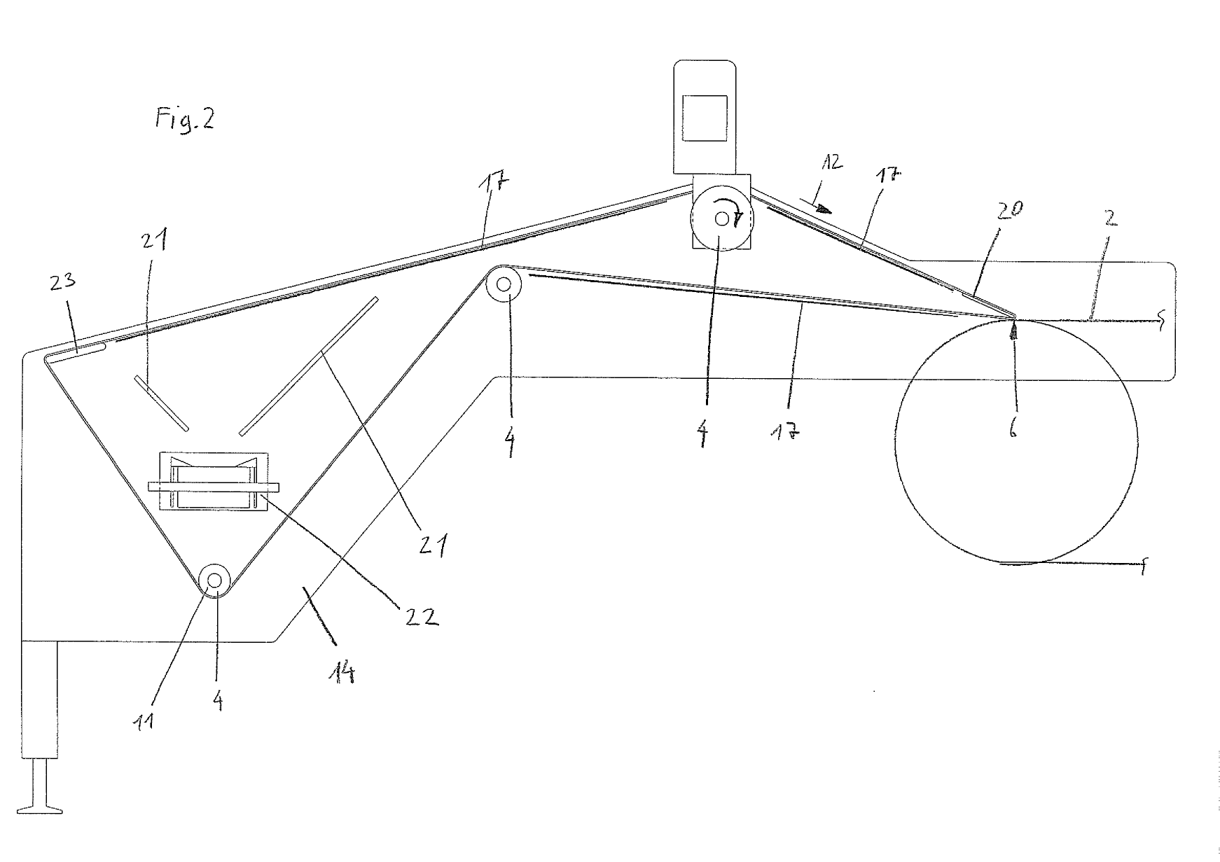

FIG. 2 shows a schematic section of the apparatus according to the invention and the schematic view of a surface of the baking oven.

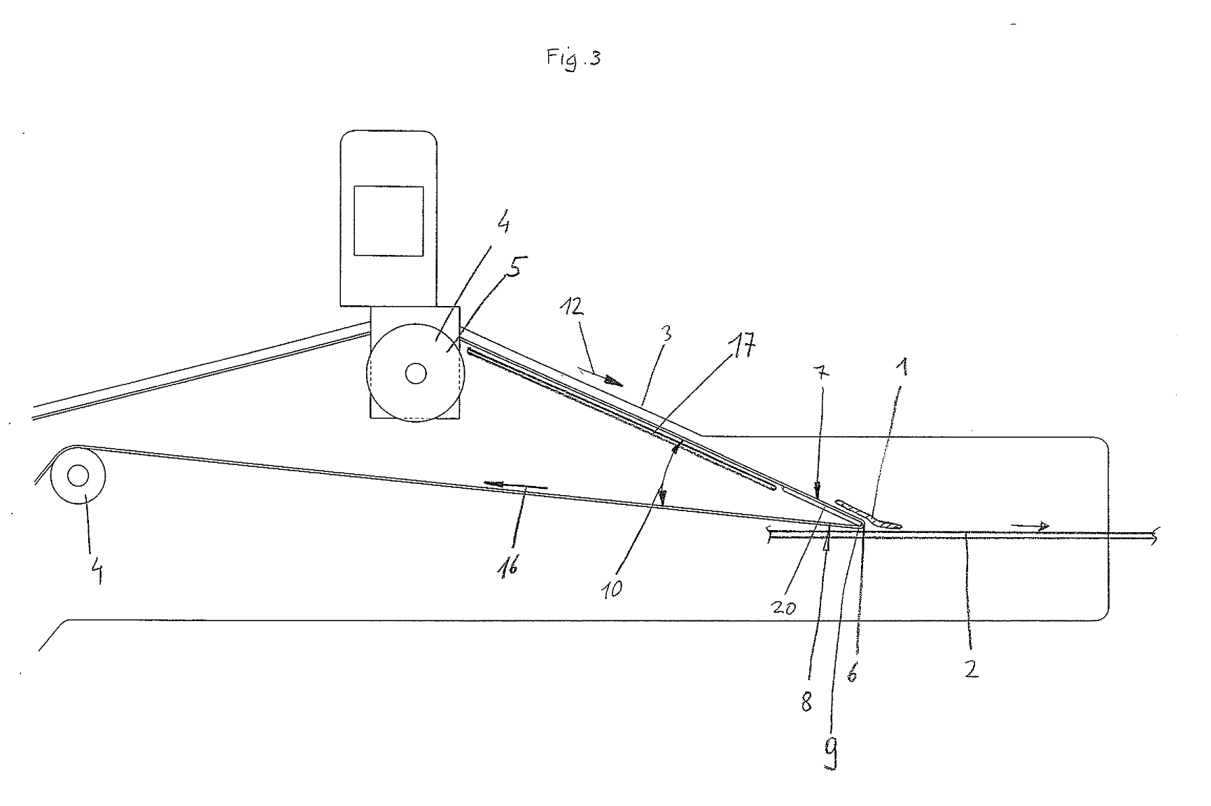

FIG. 3 shows a detailed schematic view of the transfer edge.

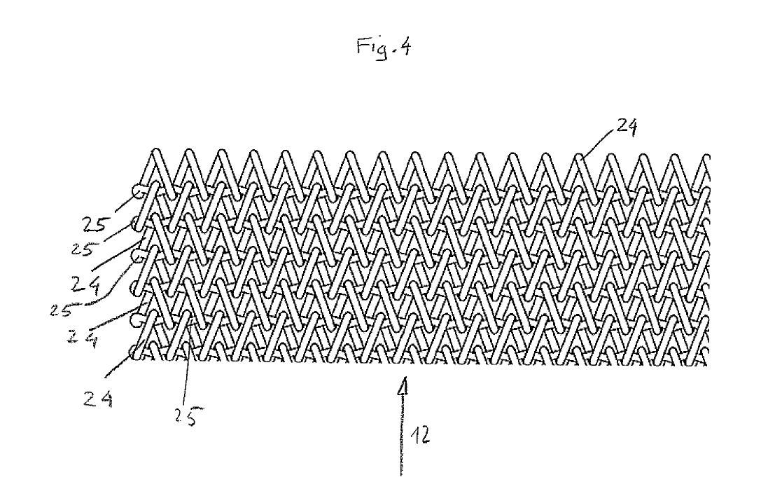

FIG. 4 shows a view of a preferred embodiment of a discontinuous belt.

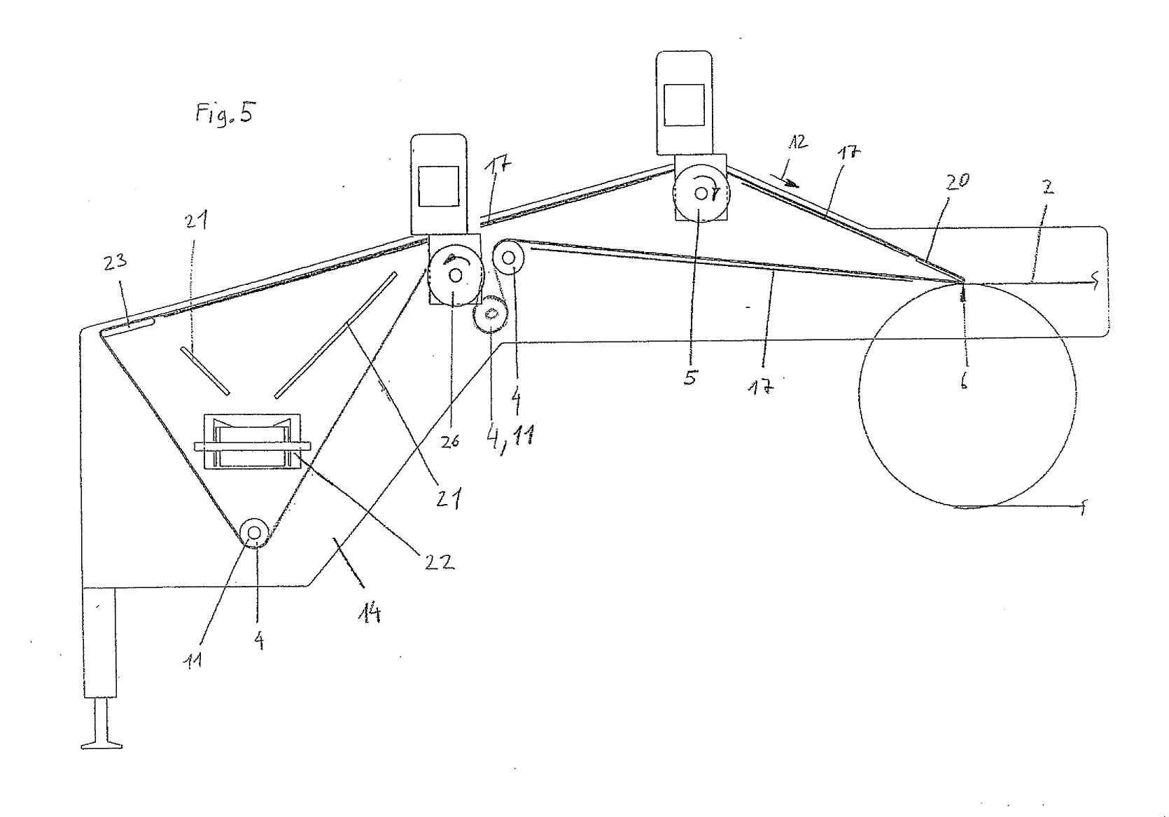

FIG. 5 shows a further schematic view of the apparatus according to the invention.

FIG. 1 shows an oblique view of an apparatus according to the invention comprising a conveyor belt 3, which is guided over a plurality of deflecting rollers 4. One of the deflecting rollers 4 is designed as a guide roller 5. This has a drive 13 for the rotary drive of the drive roller 5. The deflecting rollers are provided on a machine frame 14 or mounted in the machine frame 14 via bearings 15. The conveyor belt 3 is guided closed as an endless conveyor belt around the deflecting rollers and over at least one transfer edge 6. The drive roller 5 is disposed in the transport direction upstream of the transfer edge 6, preferably directly upstream of the transfer edge 6. The starting region 7 is located in the transport direction 12 upstream of the transfer edge 6. The discharge region 8 is located downstream of the transfer edge in the transport direction 12. According to the present invention, the conveyor belt 3 has the lowest tensile stress in the region between the drive roller 5 and the transfer edge 6, in particular in the starting region 7. The lowest tensile stress in the course of the circulating conveyor belt is defined as the lowest tensile stress. Starting from the drive roller 5 a plurality of elements liable to friction such as, for example, deflecting rollers 4 and/or deflecting edges are provided. The tensile stress at each element liable to friction increases further along the transport direction 12 of the conveyor belt 3. Furthermore, guide means 17—not shown in FIG. 1—are provided between the elements. These are used to support the conveyor belt 3 between the deflecting elements. These are also liable to friction, albeit slightly, and contribute to increasing the tension of the conveyor belt. The highest conveyor belt tension therefore lies in the region upstream of the drive roller 5 in the transport direction 12.

As a result of the arrangement of the drive roller 5 according to the invention, the starting region 7 of the transfer edge 6 is substantially strain-relieved or at least resistance-strain-relieved. Depending on the tension of the conveyor belt 3, the tensile stress in this region can be completely relieved, for example, have a negative value or have a basic tension. A negative tensile stress corresponds to a shifting of the conveyor belt in the region between drive roller 5 and the transfer edge 6. Due to the design of the conveyor belt 3 as a discontinuous belt, shear forces can be transmitted depending on the design of the discontinuous belt. In the case of compressible discontinuous belts such as, for example, spiral spring belts, according to the invention a compression of the individual elements of the belt can occur. However the compressibility of spiral link belts is limited. Consequently, if the spiral link belt is compressed in such a manner that the transverse elements abut against one another or cannot be further compressed as a result of longitudinal elements, a compressive force can also be transferred via spiral link belts.

A deflecting blade 20 is provided on the machine frame 14 to form the transfer edge. This can, for example, be rigidly connected to the machine frame or be disposed displaceably to a certain extent. In particular, the deflecting blade can have a height adjustment 16 in order to be able to adjust and/or vary the distance between the conveyor belt 3 and the surface 2.

The apparatus according to the invention is preferably used “inline” in a line for producing baked goods. In particular, the apparatus is adapted to convey substantially non-rigid shaped bodies such as, for example, unbaked cookie shaped bodies from, for example, a cutting-out apparatus for forming, for example, round cookies to a surface 2, for example, the oven belt of a cookie baking oven.

The apparatus, in particular the machine frame 14, can be designed to be self-supporting, as a component of the baking oven or as a component of the cutting apparatus.

In the present embodiment the apparatus according to the invention comprises guide means 27. These extend in a band or strip shape in the region of the drive roller 5 or in the region of the conveyor belt 3. As a result of the strain relief and/or the resistance strain relief, there is an increased risk that the drive roller 5 cannot reliably transfer the movement to the conveyor belt 3. As a result of the low tension and the small wrap-around angle, increased slippage can occur. In the case of discontinuous conveyor belts which are driven, for example, by toothed wheels or toothed rollers, skipping of the chain-shaped conveyor belt 3 over the teeth of the drive roller 5 can occur. The conveyor belt 3 is pressed onto the drive roller 5 by the guide means 27 or at least held in the region in order to ensure the reliable drive. In the case of drive rollers 5 engaging in a tooth-shaped manner in the conveyor belt 3, the guide means 27 are disposed following the course of the conveyor belt 3. The distance from the drive roller 5 is selected in such a manner that an engagement of the teeth of the drive roller 5 is ensured at each time point. The apparatus therefore comprises the conveyor belt and the guide means 27 holding the drive roller in engagement.

Optionally the guide means can press pre-tensioned against the conveyor belt 3 or have a certain play or a certain gap from this.

The guide means 27 are necessary in particular as a result of the arrangement of the drive roller according to the invention in the region upstream of the transfer edge.

FIG. 2 shows a schematic sectional view of the apparatus according to the invention. In this case, a conveyor belt 3 is guided around deflecting rollers 4 and around a transfer edge 6. The transfer edge 6 is disposed in the region of the surface 2. For transfer of the shaped bodies 1, the conveyor belt 3 is guided around a deflecting blade 20 at the transfer edge 6. In order to achieve an optimal transfer of the substantially non-rigid shaped body 1 from the conveyor belt 3 onto the hot surface 2, the transfer edge 6 is preferably designed to be as sharp as possible. This means that the deflection radius of the conveyor belt 3 at the transfer edge 6 or around the deflecting blade 20 is as small as possible. The deflection radius is limited as a result of the mechanical properties of the deflection of a discontinuous belt substantially consisting of rigid links. According to the present invention, the deflecting blade is provided on the inner side of the conveyor belt 3 and connected to the machine frame 14. The connection between the deflecting blade 20 and the machine frame 14 can be designed to be rigid or movable. For example, the deflecting blade 20 is disposed displaceably and fixedly in order to allow a coarse or fine adjustment of the positioning of the transfer edge 6 with respect to the machine frame 14 or with respect to the surface 2. This is accomplished, for example, by means of the height adjustment 16. Guide means 17 are provided for guidance of the conveyor belt 3. In the present embodiment these are designed as guide means 17 following the conveyor belt 3. For example, a plate or guide strips running underneath the conveyor belt 3 are provided as guide means 17. This supports the conveyor belt against sagging in the direction of gravity. Further embodiments of the guide means 17 can be guide rollers, guide grids, guide rollers etc.

The conveyor belt is preferably designed as a discontinuous belt, in particular as a discontinuous metal belt. This has openings through which, for example, smaller particles such as scattered material, nut pieces, dough pieces or liquids such as glazings etc. can pass. This is an advantage of the present apparatus since these contaminants can fall through the conveyor belt and consequently are not conveyed onto the surface 2 of the baking oven. A collector 22 is provided underneath the conveyor belt 3 to collect the contaminants. A funnel apparatus 21 is provided above the collector 22, which is adapted to guide impurities into the collector 22. Preferably a roller is designed as tensioning roller 11. This is provided, for example, pre-tensioned pressing against the conveyor belt 3 on the machine frame 14 in order to apply a desired pre-tension to the conveyor belt. A second deflecting blade 23 is provided in the rear region facing away from the transfer edge 6. According to an alternative embodiment, however the second deflecting blade 23 can also be replaced by a deflecting roller.

FIG. 3 shows a detailed view of the apparatus according to the invention in particular in the region of the transfer edge 6. The conveyor belt 3 is guided as in the preceding embodiments circulating along the transport direction 12 around a plurality of deflecting rollers 4 and around one or more deflecting blades 20, 23. One of the deflecting rollers 4, in particular the deflecting roller 4 which lies upstream of the transfer blade in the transport direction 12 is designed as drive roller 5. The drive roller 5 must not necessarily be designed as deflecting but can also be designed as a pure drive roller. The conveyor belt 3 is driven by this according to the previous description. For transfer of the shaped bodies 1 onto the surface 2, a small deflection radius of the conveyor belt 3 around the deflecting blade 20 is preferably provided. This deflection radius preferably corresponds to less than 5 mm, particularly preferably less than 3 mm. Consequently, the radius of curvature of the deflecting blade around the deflecting edge 6 about which the conveyor belt 3 is deflected is less than 5 mm, preferably less than 3 mm. The conveyor belt 3 is in this case made of a heat-resistant material such as, for example, metal. Furthermore, the conveyor belt 3 is designed as a discontinuous belt and comprises a plurality of substantially stiff elements arranged one after the other in a chain shape which form a flexible belt. Preferably the flexible belt is length-limited in the tensile direction but compressible in the compression direction. This means that the discontinuous belt has a maximum length under linear tension. With increasing tension, the tension in the material of the elements varies. However, the length of the belt remains substantially the same. If a compressive force is applied to the belt in the main direction of extension of the belt, the belt is thus compressible to a certain extent. The individual elements of the belt move closer to one another. In this state it is completely strain-relieved.

Guide means 17 are provided for supporting the conveyor belt 3, in particular for supporting against gravity.

At the deflecting blade 20 the conveyor belt 3 is deflected around the transfer edge 6. The deflection angle in this case is preferably between 5° and 45°. This angle corresponds to that angle which is subtended between the conveyor belt 3 in the starting region 7 and the conveyor belt 3 in the discharge region 8.

FIG. 4 shows an exemplary embodiment of a discontinuous belt which can be used as conveyor belt 3. This comprises or consists substantially of heat-resistant elements. Heat-resistant in this context is defined as a temperature resistance so that no damage occurs due to the heated surface 2. The product Cleatrac balanced weave, CTB60-60-18 from Ashworth Bros., Inc. is cited as an exemplary embodiment of a conveyor belt.

Further possible alternative embodiments, in particular alternative sizes, shapes or materials are also consistent with the inventive idea. The embodiment of FIG. 4 comprises a spiral link belt. This is shown schematically as a subregion in a plan view. It comprises a plurality of elements, in particular spiral elements 24 and transverse elements 25. The spiral elements 24 are zigzag-shaped or spiral-shaped elongated elements running substantially transversely to the transport direction 12. These are disposed parallel to one another along the transport direction 12. The individual spiral elements 24 are connected via the transverse elements 25. These are disposed rectilinearly or in a corrugated manner and also parallel to one another in transport direction 12. The spiral elements 24 are wound helically in each case around at least one, preferably two transverse elements. In each case one transverse element is also wrapped around by a following spiral element. As a result of this overlap, the individual spiral elements 24 are connected to one another by the transverse elements 25. As a result of the parallel arrangement of the elements 24, 25, a simple deflection around a straight line which runs substantially normally to the transport direction 12 is possible. By inclining the belt or by means of a sloping design however, it is possible to have a deflection around an edge which does not run normally to the transport direction 12. If a tensile force is exerted on the conveyor belt 3, the spiral link belt is located in the pulled-out position, i.e. the spiral elements 24 abut against the respective transverse elements 25 both in the front and in the rear position. This position corresponds to a tensioned chain. If a compressive force is now applied to the discontinuous belt or at least the tension is set to zero, the spiral elements 24 can be moved towards one another. In this case, the spiral elements 24 optionally lose contact with the transverse elements 25. The conveyor belt 3 is therefore compressible. The compressibility is limited by the fact that the individual spiral elements 24 abut against one another from a certain compression.

FIG. 5 shows a further embodiment of the apparatus according to the invention. A conveyor belt 3 is guided around a plurality of deflecting rollers 4 and over a transfer edge 6. In this case, a deflecting roller 4 is optionally designed as a tensioning roller 11. Furthermore a plurality of drive rollers are provided in the course of the conveyor belt. The second drive roller 26 is located in a region far from the transfer edge 6. This is disposed substantially according to the prior art. In order to allow the deflection of the conveyor belt 3 according to the invention around the transfer edge 6, a drive roller 5 is provided. The drive roller 5 is disposed in the region upstream or directly upstream of the transfer edge 6. The drive roller 5 is used for strain relief of the conveyor belt 3 in the starting region 7 of the transfer edge 6. According to this embodiment, a conventional belt conveyor having a discontinuous belt can thus be used, which additionally has a drive roller 5 according to the invention for strain relief and for deflection of the conveyor belt 3 around the transfer edge 6.

For better understanding, some terms are defined hereinafter:

A body which has a very low bending strength—for example, raw cookie bodies, dough pieces etc. is defined as a substantially non-rigid shaped body. As a result of the non-existent stiffness, these bodies can only be transferred via gaps having small gap width since otherwise the shaped bodies would be damaged.

A state of tension of the conveyor belt in which none, only very small tensile forces or the basic stresses are present is described as substantially strain-relieved or resistance strain-relieved. This is achieved in the present invention whereby the drive roller is preferably disposed directly upstream of the transfer edge.

Disposed directly upstream of the transfer is deemed to be an arrangement in which the conveyor belt is between the drive roller and the transfer edge substantially free from the elements liable to friction which contact the conveyor belt or free from elements which increase the tensile force of the conveyor belt which contact the conveyor belt. Plate-shaped or strip-shaped guide means are certainly liable to friction but do not increase the tensile force since compared to the tension due to gravity, the tensile force is reduced when the guide means are omitted. The guide means optionally serve to support the belt in order to avoid sagging in the direction of gravity. This support of the conveyor belt 3 is advantageous since otherwise the tension would be increased again due to sagging under the influence of gravity. The guide means can, for example, be designed as plate-shaped bodies or strips which extend below the conveyor belt in the transport direction.

If rollers liable to friction were provided between the transfer edge and the drive roller, this would in turn result in tension of the belt. Consequently the region should be free from deflecting rollers liable to friction. Deflecting rollers liable to friction are, for example, tensioning rollers or deflecting rollers.

Although the basic idea of the invention is not restricted to dimensions, exemplary dimensional information are given hereinafter: the shaped bodies preferably correspond to non-rigid shaped bodies having a thickness of 1 mm to about 10 mm. The area of the shaped bodies can be 1 to about 30 cm² and more.

### REFERENCE LIST

1. Shaped body
2. Surface
3. Conveyor belt
4. Deflecting roller
5. Drive roller
6. Transfer edge
7. Starting region
8. Discharge region
9. Deflection radius
10. Deflection angle
11. Tensioning roller
12. Transport direction
13. Drive
14. Machine frame
15. Bearing
16. Height adjustment
17. Guide means
18. -
19. -
20. Deflecting blade
21. Funnel apparatus
22. Collector
23. Second deflecting blade
24. Spiral elements
25. Transverse elements
26. Second drive roller
27. Guide means

1-13. (canceled)

14. An apparatus for transporting and for transferring substantially non-rigid cookie shaped bodies onto a heated surface, the apparatus comprising:
at least one deflecting roller, a drive roller, and a transfer edge disposed in a vicinity of the heated surface;
a circulating, driven belt-shaped conveyor belt, which is guided around said at least one deflecting roller, around said drive roller and around said transfer edge at the heated surface;
said conveyor belt being a discontinuous belt and said conveyor belt being substantially resistance-strain relieved in a starting region of said transfer edge when said conveyor belt is moving.

15. The apparatus according to claim 14, wherein the heated surface is a baking belt of a baking machine.

16. The apparatus according to claim 14, wherein said transfer edge has a maximum deflection radius of 5 mm.

17. The apparatus according to claim 16, wherein said transfer edge has a maximum deflection radius of 3 mm.

18. The apparatus according to claim 14, wherein said transfer edge has a maximum deflection angle of 45.

19. The apparatus according to claim 18, wherein said transfer edge (6) has a maximum deflection angle of 20.

20. The apparatus according to claim 14, wherein a region between said drive roller and said transfer edge is free from deflection rollers contacting said conveyor belt, free from deflection rollers causing friction and contacting said conveyor belt, and/or free from elements which increase a tensile force of said conveyor belt and which contact said conveyor belt.

21. The apparatus according to claim 14, wherein at least one said deflection roller is a tensioning roller.

22. The apparatus according to claim 14, wherein said conveyor belt is a discontinuous metal belt.

23. The apparatus according to claim 14, wherein said discontinuous metal belt is selected from the group consisting of a chain belt, a link belt, a spiral link belt, and a compressible spiral link belt.

24. The apparatus according to claim 14, wherein said transfer edge is a deflection edge formed on a deflection blade and said deflection blade is movably disposed for positioning with respect to the heated surface.

25. The apparatus according to claim 14, wherein said conveyor belt is formed with openings for passage of contaminants, liquids or scattered bodies.

26. The apparatus according to claim 25, which comprises a collector for collecting contaminants, liquids or scattered bodies passing through said conveyor belt.

27. The apparatus according to claim 14, which comprises guide devices disposed to guide said conveyor belt and/or for supporting said conveyor belt against gravity.

28. The apparatus according to claim 14, wherein said guide devices are disposed to follow a desired profile of said conveyor belt.

29. The apparatus according to claim 14, configured for transferring substantially non-rigid shaped bodies from a cutting-out system to an industrial cookie baking oven.

30. A cookie baking oven, comprising an apparatus according to claim 14 for transporting substantially non-rigid cookie-shaped bodies onto a baking surface.
